(19) United States
(12) Patent Application Publication
(10) Pub. No.: US 2026/0073720 A1
(43) Pub. Date: Mar. 12, 2026

(54) METHODS, APPARATUS, AND COMPUTER PROGRAM PRODUCTS FOR PROGRESSIVELY TRAINING A MODEL AND GENERATING NATURAL LANGUAGE OUTPUTS

(71) Applicant: The University of North Carolina at Charlotte, Charlotte, NC (US)

(72) Inventors: Srijan Das, Charlotte, NC (US); Dominick Reilly, Charlotte, NC (US)

(21) Appl. No.: 19/327,492

(22) Filed: Sep. 12, 2025

Related U.S. Application Data
(60) Provisional application No. 63/693,982, filed on Sep. 12, 2024.

(51) Int. Cl. G06V 20/70; G06T 7/20; G06T 7/70; G06V 10/764; G06V 10/77

(52) U.S. Cl. CPC G06V 20/70; G06T 7/20; G06T 7/70; G06V 10/764; G06V 10/7715; G06T 2207/20044

(57) ABSTRACT

Described herein are apparatuses, methods, and computer program products for progressively training a model using video data comprising a plurality of modalities and corresponding natural language labels. The plurality of modalities comprise at least a video modality, an object modality, and a skeleton modality. Aa first stage includes individually projecting each of the video modality, the object modality, and the skeleton modality into an embedding space of the model. A second stage includes combining and projecting the video modality and the skeleton modality into the embedding space. A third stage includes combining and projecting the video modality, the object modality, and the skeleton modality into the embedding space. A language vision prediction system accesses the progressively trained model to ingest video data and to generate a natural language output associated with the video data.

### CROSS REFERENCE TO RELATED APPLICATION

This application claims priority to U.S. Provisional Application 63/693,982, filed Sep. 12, 2024, the entire contents of which are hereby incorporated by reference.

### GOVERNMENT LICENSE RIGHTS

This invention was made with government support under 2245652 awarded by the National Science Foundation. The government has certain rights in the invention.

### TECHNICAL FIELD

Embodiments of the present disclosure relate generally to large language models and, more particularly, to methods, apparatuses, and computer program products for progressively training a model using video data comprising a plurality of modalities and corresponding natural language labels.

### BACKGROUND

Current Large Language Vision Models (LLVMs) trained on web videos perform well in general video understanding but struggle with fine-grained details, complex human object interactions (HOI), and view-invariant representation learning essential for Activities of Daily Living (ADL). This limitation stems from a lack of specialized ADL video instruction-tuning datasets and insufficient modality integration to capture discriminative action representations.

### BRIEF SUMMARY

Methods, apparatuses, and computer program products are therefore provided for progressively training a model of a language vision prediction system using video data comprising a plurality of modalities and corresponding natural language labels, and utilizing the progressively trained model to generate natural language outputs associated with video data.

An apparatus is provided, comprising at least one processor and at least one memory including computer program code, the at least one memory and the computer program code configured to, with the processor, cause the apparatus to at least progressively train a model using (a) video data comprising a plurality of modalities, the plurality of modalities comprising at least a video modality, an object modality, and a skeleton modality, and (b) corresponding natural language labels. In some embodiments, progressively training the model comprises, in a first stage, individually projecting each of the video modality, the object modality, and the skeleton modality into an embedding space of the model, in a second stage, combining and projecting the video modality and the skeleton modality into the embedding space, and in a third stage, combining and projecting the video modality, the object modality, and the skeleton modality into the embedding space.

In some embodiments, progressively training the model further comprises aligning each modality with the embedding space using modality specific connectors. In some embodiments, progressively training the model further comprises projecting each of the plurality of modalities into the embedding space using a linear projection layer to generate input token representations for each of the plurality of modalities. In some embodiments, video data undergoes a semi-automated data curation process. In some embodiments, the semi-automated data curation process comprises person augmented generation, temporal stitching, and weakly supervised video descriptions. In some embodiments, the person augmented generation utilizes skeleton data to crop bounding boxes around individuals. In some embodiments, the temporal stitching constructs long, untrimmed video sequences by stitching together shorter clips. In some embodiments, the weakly supervised video descriptions generate image captions for each frame in a video and the image captions for each frame are synthesized into a cohesive video description. In some embodiments, the cohesive video descriptions are utilized to generate question answer pairs. In some embodiments, progressively training the model further comprises extracting human object interaction features for the object modality. In some embodiments, extracting human object interaction includes action-conditioned object detection and object localization and tracking. In some embodiments, to extract skeleton features for the skeleton modality, a dual-encoder framework combines a skeleton backbone and a frozen text encoder. In some embodiments, the skeleton backbone is pretrained on trimmed clips for skeleton action classification.

A method is provided, including progressively training a model using (a) video data comprising a plurality of modalities, the plurality of modalities comprising at least a video modality, an object modality, and a skeleton modality, and (b) corresponding natural language labels. In some embodiments, progressively training the model comprises, a first stage that individually projects each of the video modality, the object modality, and the skeleton modality into an embedding space of the model, a second stage that combines and projects the video modality and the skeleton modality into the embedding space, and a third stage that combines and projects the video modality, the object modality, and the skeleton modality into the embedding space.

Additionally, an apparatus is provided, comprising at least one processor and at least one memory including computer program code, the at least one memory and the computer program code configured to, with the processor, cause the apparatus to access a model progressively trained with (a) video data comprising a plurality of modalities, the plurality of modalities comprising at least a video modality, an object modality, and a skeleton modality, and (b) corresponding natural language labels. The at least one memory and the computer program code are further configured to ingest input video data into the model to generate a natural language output.

In some embodiments, the input video data lacks at least one of the skeleton modality or the object modality. In some embodiments, the model is trained progressively with a first stage that individually projects each of the video modality, the object modality, and the skeleton modality into an embedding space of the model, a second stage that combines and projects the video modality and the skeleton modality into the embedding space, and a third stage that combines and projects the video modality, the object modality, and the skeleton modality into the embedding space. In some embodiments, generating the natural language output comprises answering a question about an action in the input video data. In some embodiments, the model predicts a missing action in a temporal sequence of the video. In some embodiments, the missing action is a subsequent action that occurs after the end of the video.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 depicts an example system in which one or more example embodiments of the present disclosure may be performed;

FIG. 2 is a block diagram of an apparatus configured in accordance with one or more example embodiments of the present disclosure;

FIG. 3 illustrates an example process for curating an ADL-X dataset in accordance with some example embodiments of the present disclosure

FIG. 4 illustrates an example process for utilizing the language vision prediction system comprising a plurality of modalities in accordance with some example embodiments of the present disclosure;

FIG. 5 illustrates an example schematic of the language vision prediction system in accordance with some example embodiments of the present disclosure;

FIG. 6 illustrates an example schematic the multi-modalities of ADL-X dataset in accordance with some example embodiments of the present disclosure;

FIG. 7 illustrates an example process for progressively training a model using video data comprising a plurality of modalities in accordance with some example embodiments of the present disclosure;

FIG. 8 illustrates an example input video data inserted into the language vision prediction system to generate a natural language output in accordance with some example embodiments of the present disclosure; and

FIG. 9 is a flowchart of operations that may be performed in accordance with some example embodiments.

### DETAILED DESCRIPTION

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The present disclosure addresses important technical challenges in the field of large language vision models (LLVMs). Certain example embodiments disclosed herein utilize multiple modalities and corresponding natural language labels to model the complex spatiotemporal relationships present in videos, such as videos capturing activities of daily living (ADL). Such videos may capture simple daily tasks such as preparing food, drinking water, brushing teeth, cleaning, eating food, utilizing technology, etc. The scenes captured by ADL videos lack strict temporal structure where diverse actions may unfold concurrently within a single sequence. For instance, a person cooking could intermittently engage in unrelated activities like making a phone call or drinking water, disrupting the linear progression of the composite act of cooking. Thus, because of the lack of strict temporal structure, existing LLVMs trained on web videos struggle to capture such visually perplexing dynamics inherent in ADL scenarios. The current disclosure addresses this problem by utilizing cues such three dimensional (3D) skeletons or human-object interactions (HOIs). These cues are crucial for understanding ADLs which in turn facilitate the learning of view-invariant representations and capture fine-grained details essential for interpreting complex human activities.

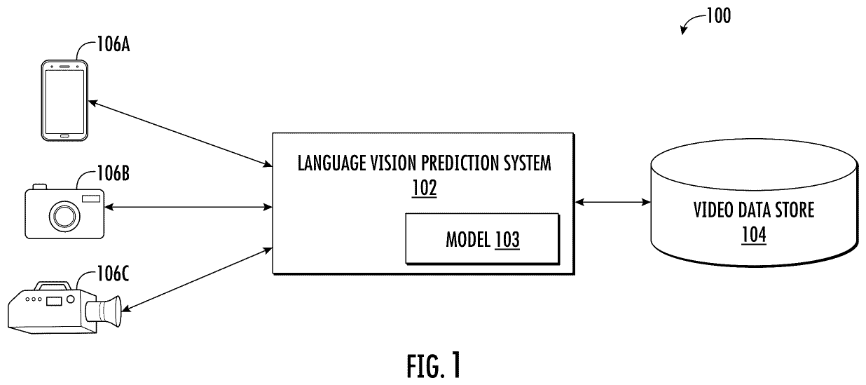

FIG. 1 illustrates a block diagram of a system 100. The system comprises a language vision prediction system 102, a video data store 104, and a plurality of devices 106A-C. The language vision prediction system 102 comprises model 103. The language vision prediction system 102 receives input video from the devices 106A-C. In some embodiments, the devices 106A-C have captured the input video. In some embodiments, the devices may have downloaded the input video from an external source. In some embodiments, the input video captures an ADL. The language vision prediction system 102 progressively trains the model using a dataset stored in the video data store 104, and corresponding natural language labels to generate natural language output based on the input video. The progressive training of the model is described in further detail herein. In some embodiments, an ADL-X dataset is stored in the video data store 104. According to certain embodiments, the language vision prediction system 102 transmits the natural language output to a device, such as but not limited to the devices 106A-C. In some embodiments, the devices may comprise a mobile device, digital camera, camcorder, webcam, tablet, action camera, UAV, computer, etc.

The model 103 of the language vision prediction system comprises a neural network configured to learn multimodal representations from video data. In some embodiments, model 103 is implemented as a multi-stage deep neural network that integrates modality-specific encoders and a large language model (LLM). The neural network of model 103 includes multiple components designed to process and integrate multimodal video data. Each modality, such as video, object, and skeleton/pose, is first processed by a dedicated encoder. For example, video frames may be processed using a convolutional neural network (CNN), human-object interaction (HOI) features may be extracted using a transformer-based object detector, and pose data may be encoded using a graph-based skeleton encoder. The HOI modality referred to as the skeleton modality can also be referred to as the pose modality. These encoders extract high-dimensional feature representations from the raw input data. The output of each encoder is then passed through a linear projection layer, which maps the modality-specific features into a shared embedding space that is compatible with the input format of the large language model (LLM). To further facilitate integration and mitigate gradient conflicts between modalities, each modality is processed through a connector module. These connectors are neural networks that adapt the features for alignment with the LLM, ensuring that each modality contributes effectively to the model's overall representation learning. During inference, the language vision prediction system 102 ingests input video data, applies it to the model, and generates natural language output, such as but not limited to answers to questions about actions depicted in the video, predictions of missing or subsequent actions, summaries of human-object interactions, and/or the like. The architecture supports flexible modality input, allowing the model to operate even when certain modalities are unavailable, by leveraging learned representations from the training phase.

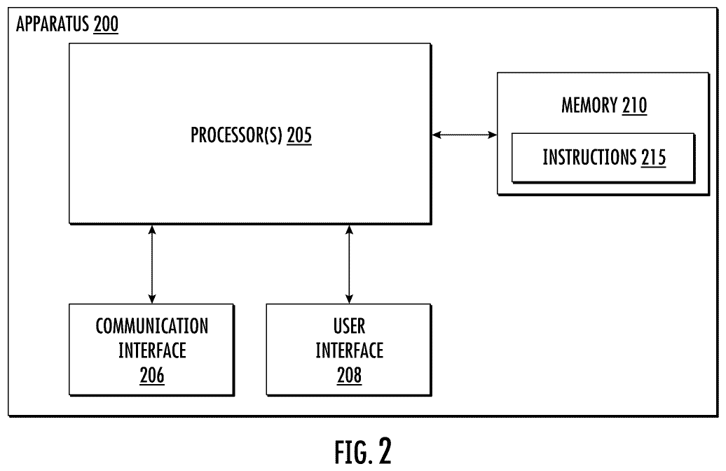

Now referring to FIG. 2, apparatus 200 is an example apparatus that can embody any of the language vision prediction system 102, the video data store 104, and the devices 106A-C. Regardless of the manner in which the apparatus 200 is embodied, the apparatus 200 includes, is associated with, and/or is in communication with: at least one processor 205, at least one memory 210, and a communication interface 215. In one or more embodiments, the apparatus 200 comprises, for example, the at least one processor 205 and the at least one memory 210 storing instructions 215 that, when executed by the at least one processor 205, cause the apparatus 200 at least to perform the method or methods as disclosed herein, and any of the embodiments thereof. In an example, the at least one memory 210 and the instructions 215 (e.g., a computer program code, software), are configured, with the at least one processor 205, to cause the apparatus 200 to perform the method or methods as disclosed herein, and any of the embodiments thereof.

In some embodiments, the processor 205 may be in communication with the memory 210 via a bus for passing information among components of the apparatus 200. The memory 210 may be non-transitory and may include, for example, one or more volatile and/or non-volatile memories. In other words, for example, the memory 210 may be an electronic storage device (e.g., a computer readable storage medium) comprising gates configured to store data (e.g., bits) that may be retrievable by a machine (e.g., a computing device like the processor). The memory 210 may be configured to store information, data, content, applications, instructions, or the like for enabling the apparatus to carry out various functions in accordance with an example embodiment of the present disclosure. For example, the memory 210 could be configured to buffer input data for processing by the processor. Additionally or alternatively, the memory 210 may be configured to store instructions for execution by the processor 205.

The processor 205 may comprise circuitry, or be constituted as circuitry or circuitries, the circuitry or circuitries being configured to perform phases of methods in accordance with certain example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 210 may be implemented using any suitable data storage technology. The memory may comprise a database for storing data. The memory 210 may be at least in part external to apparatus 200 but accessible to apparatus 200.

The instructions 215 may be comprised in a computer readable medium or a non-transitory computer readable medium. A term non-transitory, as used herein, is a limitation of the medium itself (e.g., tangible, not a signal) as opposed to a limitation on data storage persistency (e.g., random access memory, RAM, vs. read only memory, ROM).

The apparatus 200 comprises a communication interface 206. The communication interface 206 may provide the apparatus 200 with communication capabilities, such as via a wireline network. Alternatively, the communication interface 206 may comprise a receiver configured to receive information in accordance with at least one cellular or non-cellular standard. The communication interface 206 may comprise a transmitter configured to transmit information in accordance with at least one cellular or non-cellular standard.

The apparatus 200 may optionally comprise a user interface 208 comprising, for example, at least one of a keypad, a microphone, a touch display, a display, a speaker, etc. The user interface 208 may be used to control the apparatus by the user. The user interface 208 may be external to the apparatus 200. For example, the apparatus 200 may be connected to another device, such as a computer, either via wireless or wired connection, and the apparatus 200 is controlled by the user via the computer.

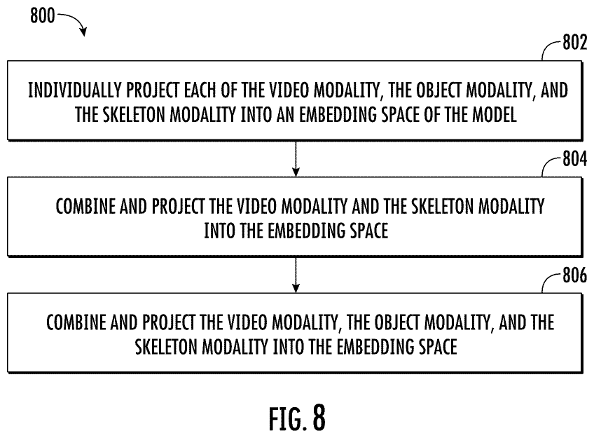

The apparatus 200 may be embodied by or otherwise associated with a station, e.g., a user equipment or other client device. In another embodiment, the apparatus is comprised in such a station, e.g. as a chipset configured to control the station. The apparatus 200 embodied by or otherwise associated with a station may be caused or configured to perform at least the method of FIG. 8, and/or any one or more of the embodiments described.

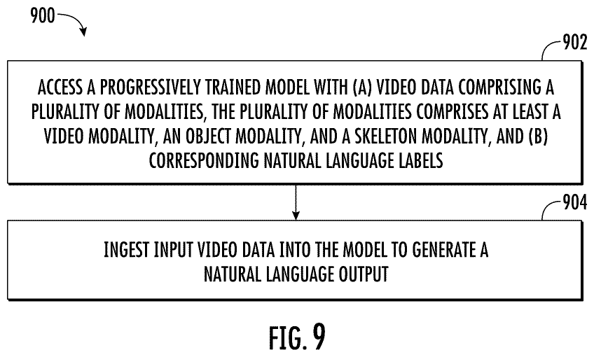

Alternatively, the apparatus 200 may be embodied by or otherwise associated with an access point. As another example, the apparatus is comprised in such an access point, e.g. as a chipset configured to control the access point. The apparatus 200 embodied by or otherwise associated with an access point may be caused or configured to perform at least the method of FIG. 9, and/or any one or more of the embodiments described.

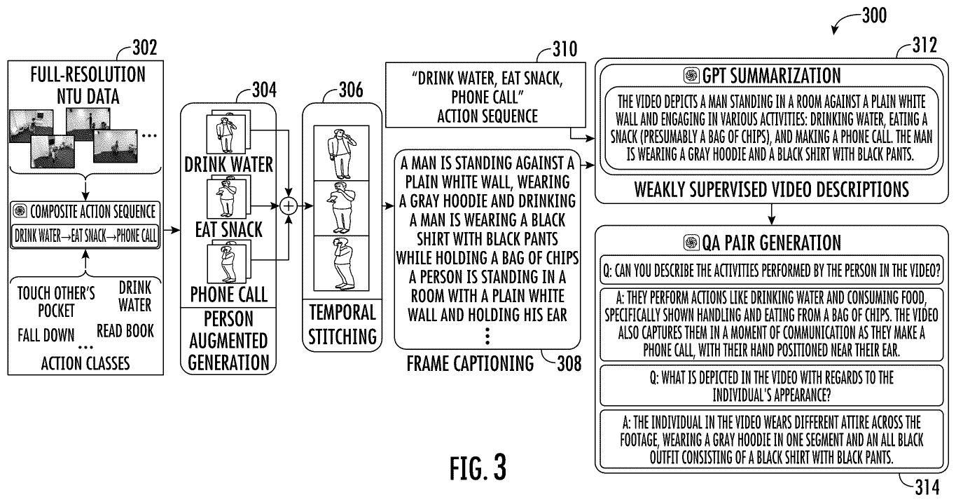

FIG. 3 illustrates an example process 300 for curating an ADL-X dataset in accordance with some example embodiments of the present disclosure. The ADL-X dataset comprises video recordings of ADLs from the NTU RGH+D 120 dataset 302. According to certain embodiments, the NTU dataset 302 is a large-scale 3D human activity understanding benchmark dataset containing over 114,000 video samples of 120 diverse active classes, including daily, health-related, and mutual actions, collected from 106 subjects. It provides synchronized RGB, depth (D), and 3D skeleton data, along with infrared videos, captured under varying environmental conditions.

In some embodiments, person augmented generation (PAG) 304 is used to generate the ADL-X dataset using the NTU dataset 302. PAG 304 utilizes skeleton data to crop bounding boxes around individuals in the NTU dataset 302 to focus on the individual's postures and their interactions with objects, distinct from the contextual background typical in web videos.

In some embodiments, temporal stitching 306 is used to generate the ADL-X data using the NTU dataset 302. For example, real-world ADL videos typically lack temporal structure, in contrast to instructional videos like cooking, where actions are sequentially linked. To mimic the inherent randomness of ADLs, composite action sequences are generated to combine individual actions from the NTU dataset's 120 diverse action classes. For instance, the combined individual actions may comprise drink water, eat snack, phone call. The clips corresponding to the chosen NTU dataset 302 action classes are stitched together.

In some embodiments, weakly supervised (WS) video descriptions 312 are used to generate the ADL-X dataset. WS video descriptions 312 are generated using frame captioning 308 for each frame in a video and synthesizing the frame-level captions into a WS video description 312 which incorporates the action sequence from the short clips stitched together during temporal stitching. In some embodiments, the cohesive video description is limited to 300 words.

In some embodiments, the WS video description is inserted into a large language model (LLM) 314 to generate question-answer (QA) pairs in a plurality of categories. In some embodiments, the categories include video summary, performed actions, spatial details, HOIs, and video-specific inquiries.

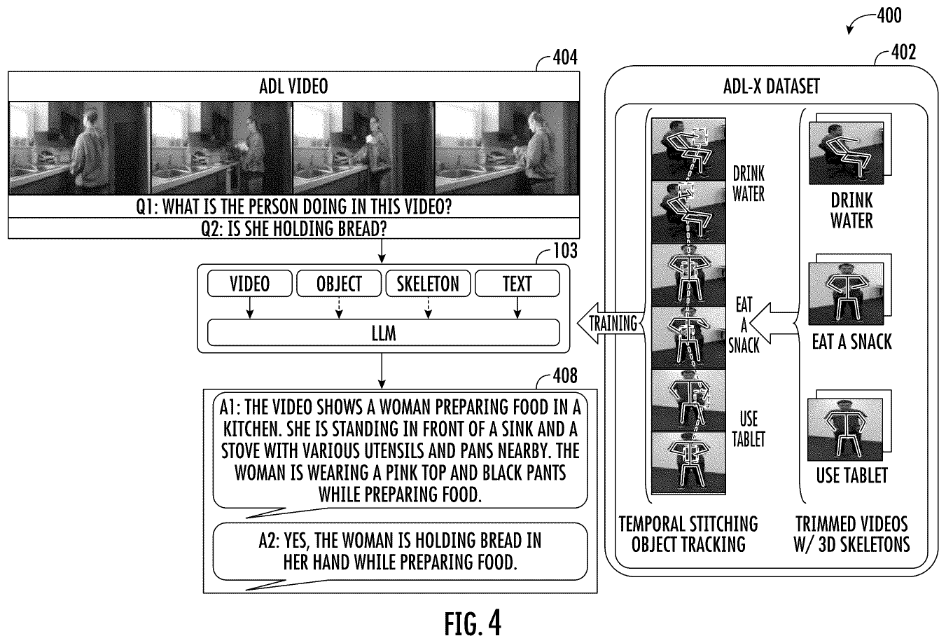

FIG. 4 illustrates an example process 400 in accordance with some example embodiments of the present disclosure. In some embodiments, the ADL-X dataset 402 is used to progressively train the model 103. The language vision prediction system video data of the ADL-X dataset comprises a plurality of modalities including video, object, skeleton, that are projected onto an LLM, alongside their natural language, or text labels and used to train the model 103. The modalities may be projected, individually and/or in various combinations, and in a series of stages as described in further detailed herein.

In some embodiments, using the trained model 103, an input video 404 (i.e., an ADL video) is ingested by the language vision prediction system 102 and applied to the model 103. According to certain embodiments, a prompt is provided in association with the input video 404. In some embodiments, the prompt may be a question or multiple questions. The language vision prediction system 102, using the progressively trained model 103, generates a natural language output 408 in response to the prompt and based on the input video. In some embodiments, the natural language output 408 is the answer to a question or to multiple questions.

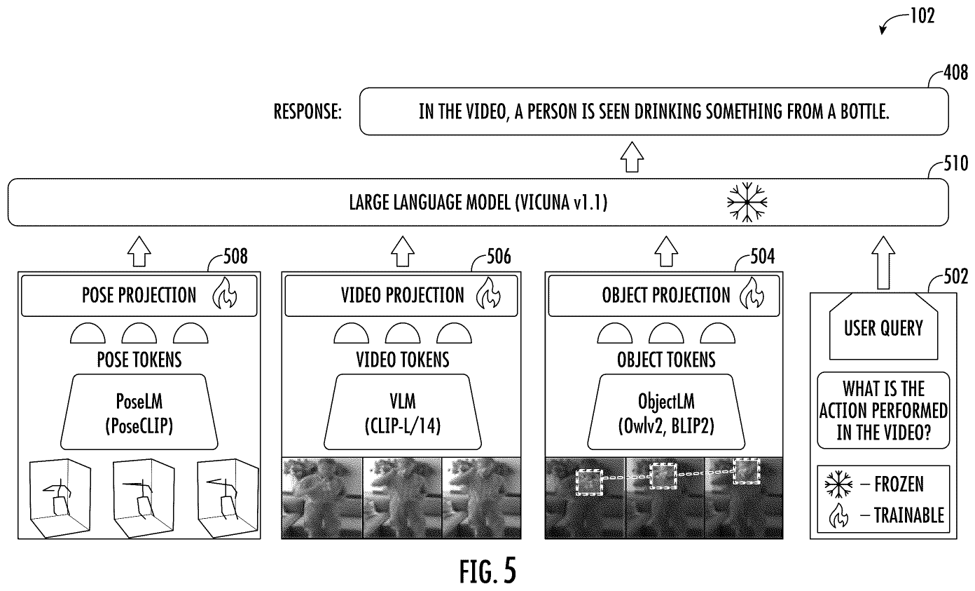

FIG. 5 illustrates an example schematic in accordance with some example embodiments of the present disclosure. Each of the plurality of modalities has a modality-specific encoder that is used to generate modality-specific tokens that are linearly projected into the LLM 510. In some embodiments, the plurality of modalities includes text 502 (i.e. the natural language labels), object 504, video 506, and pose (skeleton) 508. The text modality 502 contains prompts are tokenized into text queries for instruction tuning (i.e., natural language labels). The object modality 504 comprises an object language model that extracts HOI features. This involves two steps, action-conditioned object detection and object localization and tracking. The video modality 506 comprises a video language model. The skeleton modality 508 comprises a pose language model. Each of the plurality of modalities 502, 504, 506, and 508 are linearly projected into the LLM 510 in order to generate a natural language output 408.

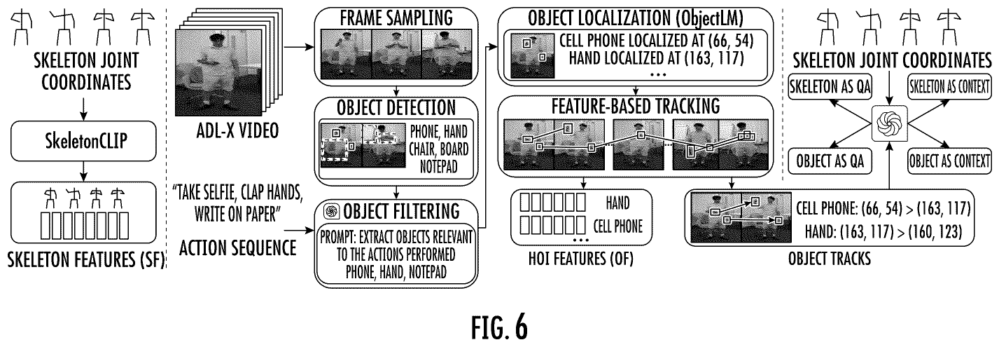

FIG. 6 illustrates an example schematic the multi-modalities of ADL-X dataset in accordance with some example embodiments of the present disclosure. Action-conditioned object detection involves extracting categories of objects present in the input video 404 that are pertinent to the actions performed with each clip. Given a stitched ADL video composed of a sequence of trimmed video segments (i.e., a clip), 8 frames are uniformly sampled from each video and inserted into a pre-trained model to generate a list of distinct objects observed in the 8 uniformly sampled frames. The list of distinct objects is refined using action labels. More specifically, for each clip in the stitched ADL video, the list of distinct objects and the action labels are input into the model 103 which is prompted to identify the object(s) most relevant to the given action. For example, if the object plant, chair, bottle, table are detected in a video labeled with the action, drinking, the progressively trained model 102 is filters out and selects “bottle” as the relevant object.

Object localization and tracking involves spatial localization of the relevant objects within the clip and the temporal association (i.e., object tracking) based on the feature similarity of the image regions corresponding to the localized objects in the ADL stitched video. In some embodiments, the list of relevant objects is input into a pre-trained open vocabulary object localization model (ObjectLM) along with the stitched video. Localization and tracking are performed on 8 frames that are uniformly sampled from the clip within the ADL stitched video. For each of the 8 frames that are uniformly sampled, object bounding boxes are detected, and features for each relevant object are extracted from the image regions within these boxes using ObjectLM. The features for n objects in frame t as

$${X}_{o}^{t} ∈ {ℝ}^{n \times {D}_{o}} ,$$

where Dₒ represents the object feature dimension. To track the relevant objects across the uniformly sampled frames, for each object in frame t, the cosine similarity between its feature vector

$${X}_{o}^{t}$$

and an feature vectors in frame t+1 corresponding to the same object category are computed. This object in frame t is then associated with the object in frame t+1 that exhibits the highest similarity score. This matching process is iterated for all objects across each frame, establishing a track for each relevant object throughout the sampled frames. Consequently, for n relevant objects detected across 8 uniformly sample frames, the object features are structured using the follow.

$$[ 〈 {X}_{o} 〉 = 〈 {X}_{o}^{1} 〉 〈 {X}_{o}^{2} 〉 … 〈 {X}_{o}^{n} 〉 ]$$

where

$${X}_{o}^{j} ∈ {ℝ}^{8 \times {D}_{o}}$$

represent the features of each tracked relevant object which are the HOI features in the video.

The skeleton modality 508 involves the extraction of features from the skeleton data Mₛ to be fed as input to LLM 510. To extract the features from the skeleton data Mₛ a skeleton-language model is used. The skeleton-language model is a dual-encoder framework that combines a skeleton backbone and a frozen text encoder. The skeleton backbone is pretrained on trimmed NTU clips for skeleton action classification. Subsequently, it is fine-tuned to enhance the alignment between skeleton features and language descriptions of actions using cross-entropy supervision. The resulting skeleton features are denoted as

$${X}_{i}^{s} ∈ {ℝ}^{{F}_{s} \times {D}_{s}} ,$$

where Dₛ indicates the dimension of skeleton features. These features are used as input tokens to the LLM 510.

In some embodiments, the 3D skeleton joint coordinates or relevant object trajectory coordinates are used alongside the associated action sequence to generate a general description of the skeleton motion or HOI of an ADL-X video. This description is then re-used to generate two QA pairs that provide detailed explanations of the skeleton and object motions. These QA pairs are then added to the training set of text queries, Qₜ, to tune the LLVM instruction.

In some embodiments, to integrate contextual information of human skeletons or HOIs, the modality-specific information is appended to the input text query Qₜ while training the LLVM. For skeleton data Mₛ, at least five peripheral joints are identified. In some embodiments, the at least five peripheral joints are the head, the right hand, the left hand, the right knee, and the left knee. For HOIs Mₒ, the trajectory coordinates of the relevant object(s) in the videos are utilized. In some embodiments, the descriptions of the motion for each of the at least five peripheral joints and the objects are generated based on their trajectories through the video, specifically focusing on how the joint and object coordinates evolve. The generated descriptions, denoted as

$${Q}_{t}^{m} \vert m = \{ s , o \} ,$$

are subsequently appended to the text query Qₜ, incorporate these skeleton or human-object descriptions as additional contextual information. Tis enriched query

$${Q}_{t}^{n e w} = [ {Q}_{t}^{m} {Q}_{f} ]$$

is then employed for instruction tuning.

The joint integration (i.e., linear projection) of the plurality of modalities into the LLM 510 presents challenges, primarily due to conflicting gradients from each of the plurality of modalities. To address this, modality-specific connectors are utilized to align each of the plurality of modalities with the LLM 510 input space. This multimodal progressive (MMPro) training strategy mitigates the challenges of training with the plurality of modalities by incrementally increasing the training complexity by progressively adding modality-specific connectors following a pre-defined growth schedule. These connectors project the modality-specific features into the LLM 510 embedding space, facilitating effective multimodal integration.

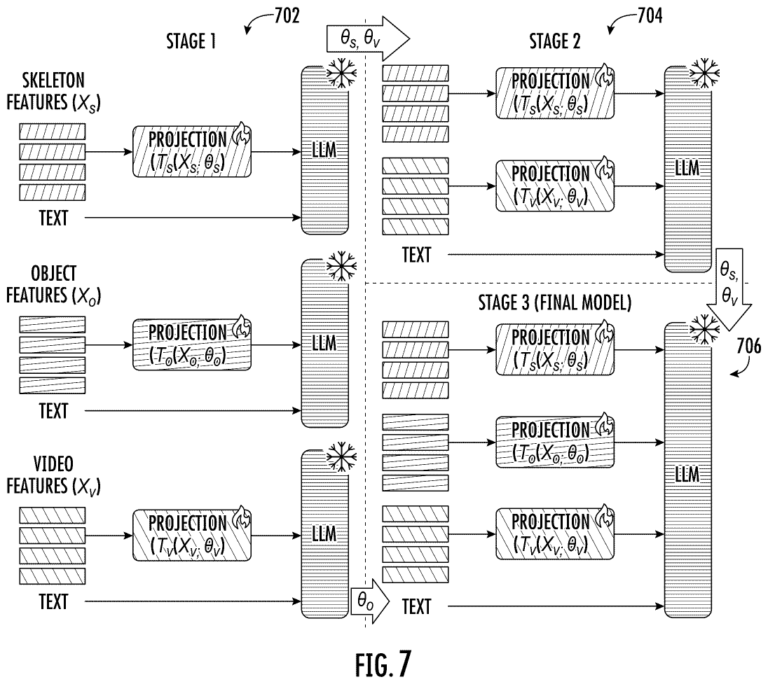

FIG. 7 illustrates an example process for progressively training a model, such as model 103, using video data comprising a plurality of modalities 502, 504, 506, and 508 in accordance with some example embodiments of the present disclosure. In some embodiments, MMPro training is structured into |η| equispaced stages with

$$\frac{\# Total iterations}{\vert η \vert}$$

iterations per stage. In some embodiments, at least three of the plurality of modalities 502, 504, 506, and 508 are projected into the LLM 510 embedding space via connectors, where η=3 stages. During stage 1, alignment of specific-modality with LLM 510 embedding space is performed. Consequently, video, skeleton, and HOI features are independently projected into the LLM 510 embedding space using linear projection layers Tₘ and their respective parameters Om for each cue m={v, s, o}, resulting in LLM input token representations of the video, skeleton, and HOI cues, respectively: Qᵥ=Tᵥ(Xᵥ;θᵥ); Qₛ=Tₛ(Xₛ;θₛ); Qₒ=Tₒ(o;θₒ) where Qₘ∈ [symbol] ^{F}^{ₘ}^{×K}. The input to the LLM 510 comprises the concatenation of Qₜ and Qₘ for m={v, s, o}, structured according to the template: [USER: [symbol] Assistant:]. This stage 1 training ensures that the video, skeleton, and HOI cues are independently aligned to the LLM 510 embedding space of the model 103. In some embodiments, the modalities are integrated in the order of skeleton modality 508 followed by the object modality 504.

In stage 2, additional modality-specific connectors are introduced. These connectors facilitate the simultaneous alignment of video and skeleton data with the LLM 510 embedding. In some embodiments, the parameters at this stage include θ_{y} and θₛ. These parameters inherit their initial values form the weights optimized during stage 1. Consequently, the input format to the LLM 510 is structured as follows: [USER: [symbol] Assistant:] where [symbol] Qₜ [symbol] , [symbol] Qᵥ [symbol] , and [symbol] Qₛ [symbol] represent the text, video, and skeleton query embeddings, respectively. This structured input format ensures a targeted integration of video and skeleton modalities during the MMPro training strategy in stage 2.

Stage 3 incorporates all modalities. The training parameters θᵥ and θₛ are further refined from their stage 2 configurations, while 0, is initialized from stage 1 training. The input to the LLM 510 at this stage includes an additional object modality, formatted as: [USER: [symbol] Assistant:]. This integration approach aligns video, object, and skeleton modalities with the LLM 510 embeddings, enhancing the model's capability to accurately process and understand ADL.

In some embodiments, when performing inference, the model 103 utilizes only the video cue, consequently eliminating the need for person-centric cropping and additional modalities. In instances such as this, the model 103 infers the data associated with the plurality of modalities based on ADL-X dataset 402 training. In some embodiments, instances such as these occur when resource constraints are present. These constraints may consist of limited resources such as an absence of sensors that can detect the needed data for the pose modality and the object modality.

It will be appreciated that the figures are each provided as examples and should not be construed to narrow the scope or spirit of the disclosure in any way. In this regard, the scope of the disclosure encompasses many potential embodiments in addition to those illustrated and described herein. Numerous other configurations may also be used to implement embodiments of the present disclosure.

FIGS. 8 and 9 are flowcharts of operations that may be performed in accordance with some example embodiments. It will be understood that each operation of the flowcharts or diagrams, and combinations of operations in the flowcharts or diagrams, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, memory 214) storing instructions executable by a processor in the computing device (for example, by processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, apparatus 200) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, apparatus 200 and/or other apparatus) to cause a series of operations to be performed on the computer or other programmable apparatus to produce a computer-implemented process such that the instructions which execute on the computer or other programmable apparatus implement the functions specified in the flowchart block(s).

Referring now to FIG. 8, operations, are illustrated for progressively training a model, such as model 103 using (a) video data comprising a plurality of modalities, and (b) corresponding natural language labels, in accordance with certain embodiments of the present disclosure. The operations of FIG. 8 may be performed by the language vision prediction system 102, such as apparatus 200.

As shown in block 802 of FIG. 8, the apparatus 200 includes means, such as the processor 205, the radio interface 206 or the like, configured to, individually project each of the video modality, the object modality, and the skeleton modality into an embedding space of the model. In some embodiments, the video modality 506, the object modality 504, and the skeleton modality, (or pose modality 508), are projected into the LLM 510 embedding space via connectors. This training ensures that the video, skeleton, and HOI cues are independently aligned to the LLM 510 embedding space of the model 103. In some embodiments, the modalities are integrated in the order of skeleton modality 508 followed by the object modality 504.

As shown in block 804 of FIG. 8, the apparatus 200 includes means, such as the processor 205, the radio interface 206 or the like, configured to, combine and project the video modality and the skeleton modality into the embedding space. In some embodiments, the model includes additional modality-specific connectors. These connectors facilitate the simultaneous alignment of video and skeleton data with the LLM 510 embedding.

As shown in block 806 of FIG. 8, the apparatus 200 includes means, such as the processor 205, the radio interface 206 or the like, configured to, combine and project the video modality, the object modality, and the skeleton modality into the embedding space. This integration approach aligns video, object, and skeleton modalities with the LLM 510 embeddings, enhancing the model's capability to accurately process and understand ADL.

Referring now to FIG. 9, the operations for using a progressively trained model, such as model 103, to generate natural language output and/or predictions are illustrated. The operations of FIG. 9 may be performed by the language vision prediction system 102, such as apparatus 200.

As shown in block 902 of FIG. 9, the apparatus 200 includes means, such as the processor 205, the radio interface 206 or the like, to access a model progressively trained with (a) video data comprising a plurality of modalities, the plurality of modalities comprising at least a video modality, an object modality, and a skeleton modality, and (b) corresponding natural language labels. Each of the plurality of modalities has a modality-specific encoder that is used to generate modality-specific tokens that are linearly projected into the LLM 510 as discussed with respect to the disclosure of FIG. 5. The text modality 502 (i.e., the natural language labels) contains prompts that are tokenized into text queries for instruction tuning. The object modality 504 comprises an object language model that extracts HOI features through at least one of action-conditioned object detection and object localization and tracking. The video modality 506 comprises a video language model. The skeleton modality 508 comprises a pose language model. Each of the plurality of modalities 502, 504, 506, and 508 are linearly projected into the LLM 510 in order to generate a natural language output 408.

As shown in block 904 of FIG. 9, the apparatus 200 includes means, such as the processor 205, the radio interface 206 or the like, configured to ingest input video data into the model to generate a natural language output. The natural language output can include an answer to a question or prompt, a summary description of the video data, a prediction about one or more missing or subsequent actions, and/or the like.

Therefore, the present disclosure addresses important technical challenges in the field of large language vision models (LLVMs). Certain example embodiments disclosed herein utilize multiple modalities and corresponding natural language labels to model the complex spatiotemporal relationships present in videos, such as videos capturing activities of daily living (ADL). The scenes captured by ADL videos lack strict temporal structure where diverse actions may unfold concurrently within a single sequence. Thus, because of the lack of strict temporal structure, existing LLVMs trained on web videos struggle to capture such visually perplexing dynamics inherent in ADL scenarios. The current disclosure addresses this problem by utilizing cues such three dimensional (3D) skeletons or human-object interactions (HOIs). These cues assist example embodiments in understanding ADLs which in turn facilitate the learning of view-invariant representations and capture fine-grained details for interpreting complex human activities.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising:
at least one processor; and
at least one memory storing instructions that, when executed by the at least one processor, cause the apparatus to:
progressively train a model using (a) video data comprising a plurality of modalities, the plurality of modalities comprising at least a video modality, an object modality, and a skeleton modality, and (b) corresponding natural language labels, wherein progressively training the model comprises:
in a first stage, individually projecting each of the video modality, the object modality, and the skeleton modality into an embedding space of the model;
in a second stage, combining and projecting the video modality and the skeleton modality into the embedding space; and
in a third stage, combining and projecting the video modality, the object modality, and the skeleton modality into the embedding space.

2. The apparatus of claim 1, wherein progressively training the model further comprises aligning each modality with the embedding space using modality specific connectors.

3. The apparatus of claim 1, wherein progressively training the model further comprises projecting each of the plurality of modalities into the embedding space using a linear projection layer to generate input token representations for each of the plurality of modalities.

4. The apparatus of claim 1, wherein video data undergoes a semi-automated data curation process.

5. The apparatus of claim 4, wherein the semi-automated data curation process comprises person augmented generation, temporal stitching, and weakly supervised video descriptions.

6. The apparatus of claim 5, wherein the person augmented generation utilizes skeleton data to crop bounding boxes around individuals.

7. The apparatus of claim 5, wherein the temporal stitching constructs long, untrimmed video sequences by stitching together shorter clips.

8. The apparatus of claim 5, wherein the weakly supervised video descriptions generate image captions for each frame in a video and the image captions for each frame are synthesized into a cohesive video description.

9. The apparatus of claim 8, wherein the cohesive video descriptions are utilized to generate question answer pairs.

10. The apparatus of claim 1, wherein progressively training the model further comprises extracting human object interaction features for the object modality.

11. The apparatus of claim 10, wherein extracting human object interaction includes action-conditioned object detection and object localization and tracking.

12. The apparatus of claim 10, wherein to extract skeleton features for the skeleton modality, a dual-encoder framework combines a skeleton backbone and a frozen text encoder.

13. The apparatus of claim 12, wherein the skeleton backbone is pretrained on trimmed clips for skeleton action classification.

14. A method comprising:
progressively training a model using (a) video data comprising a plurality of modalities, the plurality of modalities comprising at least a video modality, an object modality, and a skeleton modality, and (b) corresponding natural language labels, wherein progressively training the model comprises:
a first stage that individually projects each of the video modality, the object modality, and the skeleton modality into an embedding space of the model,
a second stage that combines and projects the video modality and the skeleton modality into the embedding space, and
a third stage that combines and projects the video modality, the object modality, and the skeleton modality into the embedding space.

15. An apparatus comprising:
at least one processor; and
at least one memory storing instructions that, when executed by the at least one processor, cause the apparatus to:
access a model progressively trained with (a) video data comprising a plurality of modalities, the plurality of modalities comprising at least a video modality, an object modality, and a skeleton modality, and (b) corresponding natural language labels; and
ingest input video data into the model to generate a natural language output.

16. The apparatus of claim 15, wherein the input video data lacks at least one of the skeleton modality or the object modality.

17. The apparatus of claim 15, wherein the model is trained progressively with a first stage that individually projects each of the video modality, the object modality, and the skeleton modality into an embedding space of the model, a second stage that combines and projects the video modality and the skeleton modality into the embedding space, and a third stage that combines and projects the video modality, the object modality, and the skeleton modality into the embedding space.

18. The apparatus of claim 15, wherein generating the natural language output comprises answering a question about an action in the input video data.

19. The apparatus of claim 15, wherein the model predicts a missing action in a temporal sequence of the video.

20. The apparatus of claim 15, wherein the missing action is a subsequent action that occurs after the end of the video.
